(19) United States
(12) Patent Application Publication
(10) Pub. No.: US 2020/0198715 A1
(43) Pub. Date: Jun. 25, 2020

(54) LIGHTING AND A COMMUNICATION SYSTEM FOR PROVIDING COMMUNICATION BETWEEN A VEHICLE AND A HELMET

(71) Applicant: MAX SAFAI, San Juan Capistrano, CA (US)

(72) Inventor: MAX SAFAI, San Juan Capistrano, CA (US)

(21) Appl. No.: 16/108,960

(22) Filed: Aug. 22, 2018

Related U.S. Application Data
(60) Provisional application No. 62/626,105, filed on Feb. 4, 2018.

(51) Int. Cl. B62J 6/057; B62K 19/40; B62J 6/165; B62K 11/14; B62J 43/30; B62J 45/41; A42B 3/04

(52) U.S. Cl. CPC B62J 6/057; B62K 19/40; B62J 6/165; A42B 3/0453; B62J 43/30; B62J 45/41; B62K 11/14

(57) ABSTRACT

Disclosed is a lighting and communication system for providing communication between a vehicle and a helmet worn by a rider over a communication network. The lighting and communication system includes a vehicle system and a helmet system. The vehicle system attached to a handle of the vehicle, the vehicle system includes a joystick attached to the frame of the vehicle for allowing the rider to provide directional signals, a first communication unit configured in the joystick for communicating directional signals with the helmet over the communication network, and a first battery configured to power the joystick and the first communication unit. The helmet system attached to the helmet for communicating with the vehicle system. The helmet system includes a second communication unit attached to the helmet to receive the directional commands from the joystick via the first communication unit, a microprocessor attached to the helmet to process the directional commands received by the second communication unit from the first communication unit, wherein the second communication unit communicates the processed signals over the communication network, plurality of LED lights configured on the helmet to indicate movement of the vehicle based upon the movement of the joystick initiated by the rider, and a second battery configured in the helmet to power the plurality of LED lights, the second communication unit and the microprocessor. The microprocessor controls the operation of the LED lights, wherein the LED lights illuminate based on the directional signals from the joystick to reflect movement of the vehicle.

### CROSS-REFERENCE TO RELATED APPLICATION

This application claims priority to Provisional Application No. 62/626,105, filed on Feb 4, 2018 and entitled LIGHTING AND COMMUNICATING SYSTEM FOR A HELMET, which is hereby incorporated by reference herein in its entirety.

### BACKGROUND OF THE INVENTION

### 1. Field of the Invention

The present invention generally relates to a smart helmet, and more particularly relates to a lighting and a communication system for providing communication between a vehicle and a helmet over a communication network to ensure safety of a rider.

### 2. Description of Related Art

Over the recent times, there has been a substantial increase in the adoption and use of motorcycles and bicycles for various purposes varying from being a mode of commutation to mode of recreation. However, unlike the other vehicles like cars and trucks, the safety of the rider of the bicycles and motorcycles is compromised, mainly due to the challenges in providing an effective lighting system.

As per the most recent report by the Department of Transportation, there were 8.5 million motorcycles registered in the United States by private citizens and commercial organizations in 2011. There are an estimated 200 million motorcycles in the world at the moment or about 33 motorcycles per 1000 people. For many years, the world has produced over 100 million bicycles per year. Bike sharing programs in China and in France are common and becoming more.

2015 crash data: according to the U.S. Department of Transportation's National Highway Traffic Safety Administration (NHTSA), 4,976 people died in motorcycle crashes in 2015, up 8.3 percent from 4,594 in 2014. In 2015, 88,000 motorcyclists were injured, down 4.3 percent from 92,000 in 2014.

Motorcycles & Bicycles are harder to notice than cars since they are much smaller in size and therefore less visible. At night, the problem becomes worst since some of the bicycles do not use lights and most 2 or 3 wheelers, motorized or not, do not have lights at ‘eye’ level of the drivers of cars.

Further, in cases of any accidents with the rider there are no means to receive immediate communication directly from the rider vehicle. Therefore, there is a need of a lighting and communicating system to illuminate light signals for notifying others. Furthermore, the lighting and communicating system communicates position of the rider over the communication network.

### SUMMARY OF THE INVENTION

In accordance with teachings of the present invention is to provide a lighting and a communication system for communication between a vehicle and a helmet over a communication network.

An object of the present invention is to provide a lighting and communication system for providing communication between a vehicle and a helmet worn by a rider over a communication network. The lighting and communication system includes a vehicle system and a helmet system.

The vehicle system is attached to a handle of the vehicle. The vehicle system includes a joystick, a first communication unit and a first battery. The joystick is attached to the frame of the vehicle for allowing the rider to provide directional signals. The first communication unit is configured in the joystick for communicating directional signals with the helmet over the communication network. The first battery powers the joystick and the first communication unit.

The helmet system attached to the helmet for communicating with the vehicle system. The helmet system includes a second communication unit, a microprocessor, plurality of LED lights and a second battery. The second communication unit is attached to the helmet to receive the directional commands from the joystick via the first communication unit.

The microprocessor is attached to the helmet to process the directional commands received by the second communication unit from the first communication unit. The second communication unit communicates the processed signals over the communication network. The plurality of LED lights are configured on the helmet to indicate movement of the vehicle based upon the movement of joystick initiated by the rider.

The second battery is configured in the helmet to power the plurality of LED lights, the second communication unit and the microprocessor. The microprocessor controls the operation of the LED lights. The LED lights illuminate based on the directional signals from the joystick to reflect movement of the vehicle.

Another object of the present invention is to provide the lighting and communication system wherein the vehicle system further includes a brake sensor configured in a vehicle braking unit to sense braking of the vehicle. The brake sensor communicates the braking of the vehicle to the microprocessor through the first communication unit. The microprocessor operates at least one of the LED lights to indicate application of brakes by the rider.

Another object of the present invention is to provide the lighting and communication system wherein the helmet system further includes a speed unit for communicating speed and sudden change in speed of the vehicle over the communication network via the second communication network.

Another object of the present invention is to provide the lighting and communication system wherein the helmet system further includes a proximity sensor to detect approaching vehicles and further illuminates at least one of the plurality of LED lights as warning signal for approaching vehicles.

Another object of the present invention is to provide the lighting and communication system wherein the vehicle system further includes a health sensor configured on the frame of the vehicle to detect various health parameters of the rider. The health sensor communicates the health parameters through the communication network via the second communication unit.

Another object of the present invention is to provide the lighting and communication system wherein the helmet system further includes at least one camera to record digital content around the vehicle. The camera communicates the recorded digital content over the communication network via the second communication unit.

Another object of the present invention is to provide the lighting and communication system wherein the helmet system further includes a memory unit to store the digital content for a pre-defined duration before the sudden change in the speed of the vehicle detected by the accelerometer. The accelerometer sends notifications over the communication network through the second communication unit on detecting sudden change in the speed of the vehicle.

Another object of the present invention is to provide the lighting and communication system wherein the helmet system further includes a USB port to receive a power cable to charge the second battery, a smart microphone for wirelessly operating a smartphone on filtering noise from voice commands of the rider, and a wireless charging unit to wirelessly charge the first battery and the second battery.

Another object of the present invention is to provide a lighting and communication system wherein the vehicle system further includes plurality of light sensors and a first battery. At least one light sensor is attached to at least one light source of the vehicle. The light sensor detects illumination of the light source. The light sensor generates directional and light signal corresponding to the movement of the vehicle. The first battery is configured to power the light sensors.

Another object of the present invention is to provide a lighting and communication system wherein the helmet system further includes a second communication unit, a microprocessor, plurality of LED lights and a second battery.

The second communication unit is attached to helmet to receive the light signal from the light sensor. The microprocessor is attached to the helmet to process the light signals and the directional signals received by the second communication unit from the light sensors. The light signals and directional signals determines the movement of the vehicle.

The plurality of LED lights, wherein at least one of the LED lights illuminate to show movement of the vehicle corresponding to the light signals received from the light sensors. The second battery is attached to the helmet to power the plurality of LED lights, the second communication unit and the microprocessor.

The microprocessor controls the operation of the LED lights. The LED lights illuminate based on the light signals and the directional signals from the light sensors to reflect movement of the vehicle. Another object of the present invention is to provide plurality of first communication units, each first communication unit is attached to each light sensor to communicate communicates the light signals and the directional signals of the light source to the microprocessor via the second communication unit.

These and other objects, features and advantages of the invention will become more fully apparent in the following detailed description, taken in conjunction with the accompanying drawings.

### BRIEF DESCRIPTION OF DRAWINGS

FIG. 1 illustrates a block diagram of a lighting and communication system for providing communication between a vehicle and a helmet over a communication network;

FIG. 2 illustrates a perspective view of a joystick in accordance with an exemplary embodiment of the present invention;

FIG. 3A illustrates a front view of the helmet showing position of LED lights in accordance with a preferred embodiment of the present invention;

FIG. 3B is a rear view of the helmet showing position of LED lights in accordance with a preferred embodiment of the present invention;

FIG. 4 illustrates a perspective view of a vehicle braking unit 402 in accordance with another preferred embodiment of the present invention; and

FIG. 5 illustrates a rear view of an exemplary vehicle illustrating attachment of light sensors to light sources in accordance with another preferred embodiment of the present invention.

### DETAILED DESCRIPTION OF DRAWINGS

While this technology is illustrated and described in a preferred embodiment, a lighting and communication system for providing communication between a vehicle and a helmet over a communication network may be produced and described in many different configurations, forms, shapes and sizes without deviating from the scope of present invention. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

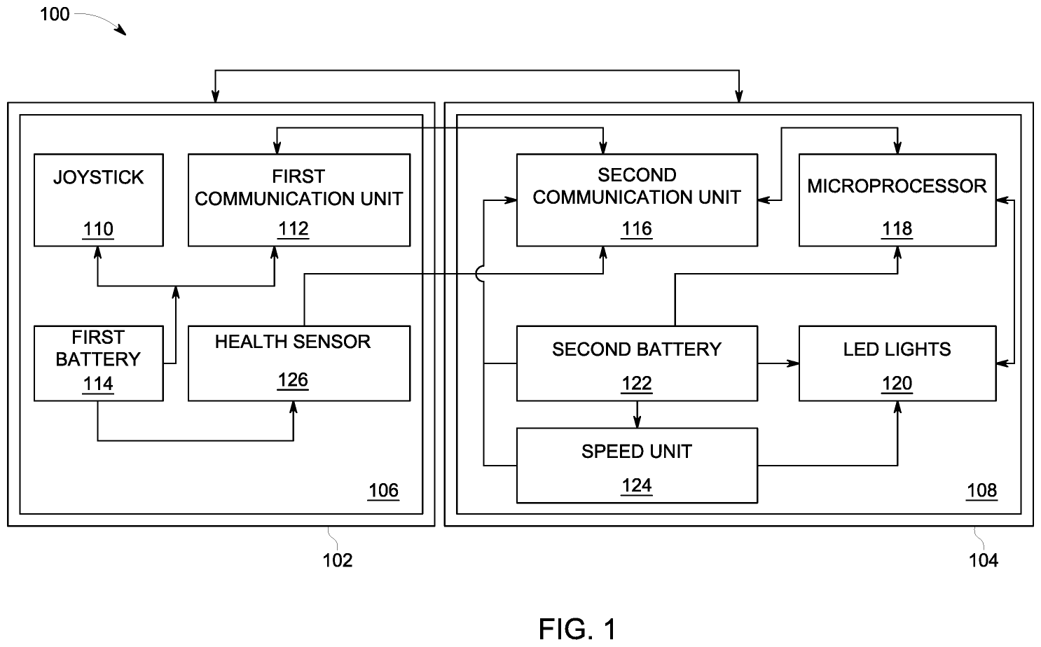

FIG. 1 illustrates a block diagram of a lighting and communication system 100 for providing communication between a vehicle 102 and a helmet 104 over a communication network. The lighting and communication system 100 includes a vehicle system 106 and a helmet system 108.

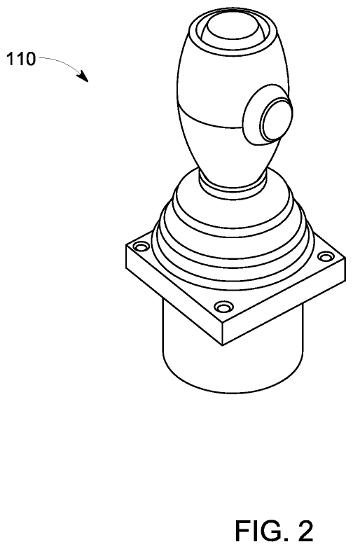

The vehicle system 106 includes a joystick 110, a first communication unit 112 and a first battery 114. The joystick 110 is attached to the frame of the vehicle 102 for allowing the rider to provide directional signals. The rider is able to rotate the joystick 110 in forward, backward, right and left direction. The joystick 110 is explained in detail in conjunction with FIG. 2 of the present invention.

The first communication unit 112 is configured in the joystick for communicating directional signals with the helmet 104 over the communication network. Examples of the first communication unit 112 include a low energy Bluetooth, GSM, CDMA, wi-fi unit etc.

The first battery 114 is configured in the joystick 110 for powering the joystick 110 and the first communication unit 112. Examples of the first battery 114 include but not limited lithium battery, rechargeable battery, solar cell powered battery etc.

The helmet system 108 is attached to the helmet 104 for communicating with the vehicle system 106. The helmet system 108 includes a second communication unit 116, a microprocessor 118, plurality of LED lights 120 and a second battery 122.

The second communication unit 116 is attached to the helmet 104 to receive the directional commands from the joystick 110 via the first communication unit 112. Examples of the second communication unit 116 include but not limited to Bluetooth, GSM, CDMA etc.

The microprocessor 118 is attached to the helmet 104 to process the directional commands received by the second communication unit 116 from the first communication unit 112. Examples of the microprocessor 118 include but not limited to microcontroller, and other similar processors containing arithmetic logic unit (ALU) and the control units. The microprocessor 118 controls the operation of the LED lights 120 on the basis of received directional signals.

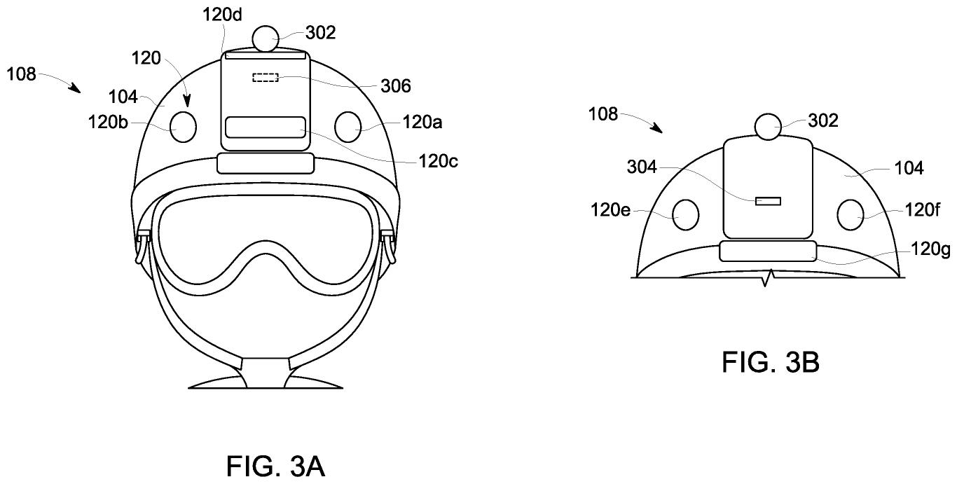

The LED lights 120 configured on the helmet 104 to indicate movement of the vehicle 102 based upon the movement of the joystick 110 initiated by the rider. The positioning and working of the LED lights 120 is shown and explained in detail in conjunction with in FIG. 3 of the present invention. The LED lights 120 illuminate based on the directional signals from the joystick 110 to reflect movement of the vehicle 102.

The second battery 122 is configured in the helmet 104 to power the plurality of LED lights 120, the second communication unit 116 and the microprocessor 118. Examples of the second battery 122 include but not limited lithium battery, rechargeable battery, solar cell powered battery etc.

In another preferred embodiment of the present invention, the plurality of LED lights 120 may be operated directly from the rider's smartphone. The smartphone may be attached to the vehicle. The smartphone may contain a mobile application that is able to send commands wirelessly to operate the LED lights 120.

Examples of the vehicle include but not limited to bicycle, motorcycle, bikes, tricycle etc. However, it would be readily apparent to those skilled in the art that various types of vehicle may be envisioned without deviating from the scope of the invention.

In another preferred embodiment of the present invention, the helmet system 108 further includes a speed unit 124 for communicating speed and sudden change in the speed of the vehicle over the communication network via the second communication unit 116.

Example of the speed unit 124 includes but not limited to a GPS unit for detecting speed of the vehicle and an accelerometer for detecting sudden change in the speed of the vehicle. In another preferred embodiment of the present invention, the speed unit 124 sends the speed of the vehicle over the communication network in real time. The speed unit 124 is further explained in detail in conjunction with FIG. 3 of the present invention.

In another preferred embodiment of the present invention, the vehicle system 106 further includes a health sensor 126 configured on the frame of the vehicle detects various health parameters of the rider. The health sensor 126 communicates the health parameters through the communication network via the second communication unit 116.

Examples of the health parameters include but not limited to blood pressure, heart rate etc. It would be readily apparent to those skilled in the art that various types of the health parameters may be envisioned without deviating from the scope of the present invention.

FIG. 2 illustrates a perspective view of a joystick 110 in accordance with an exemplary embodiment of the present invention. The joystick 110 is attached to the vehicle. In a preferred embodiment of the present invention, the rider is able to be rotate and move the joystick 110 in four directions i.e. left, right, back and forward. The movement of the joystick 110 results in producing directional signals. The first communication unit attached to joystick 110 transfers the directional signals to the second communication unit.

FIG. 3A illustrates a front view of the helmet 104 showing position of LED lights 120 in accordance with a preferred embodiment of the present invention. The LED lights 120 include a left LED light 120a, a right LED light 120b, a front LED light 120c and a position LED light 122b.

The LED lights 120 are operated by the microprocessor on receiving directional signals from the joystick 110. The left LED light 120a illuminates when the rider moves the joystick in left direction. The illumination of the left LED light 120a indicates the vehicle is about to turn in left direction.

The right LED light 120b illuminates when the rider moves the joystick in the right direction. The illumination of the right LED light 120a indicates that the vehicle is about to turn in right direction. The front LED light 120c illuminates when the rider moves the joystick 110 in forward direction.

In another preferred embodiment of the present invention, the front LED light 120c illuminates on receiving command from the speed unit (124, shown in FIG. 1). The speed unit (124, shown in FIG. 1) detects forward movement of the vehicle and thus illuminates the front LED light 120c to show the position of the vehicle. The illumination of the front LED light 120a indicates that the vehicle is going forward.

The position LED light 120d illuminates to show the presence and further communicates the position and location of the vehicle over the communication network. Thus, the vehicles or person approaching from the front of the vehicle notices the illumination of LED lights and act accordingly.

In another preferred embodiment of the present invention, the helmet system 108 includes a camera 302 to record digital content around the vehicle. Further the camera 302 communicates the recorded digital content over the communication network via the second communication unit.

Examples of the camera 302 include but not limited to a 360 degrees' camera, HD camera, trigger camera etc. It would be readily apparent to those skilled in the art that various types and number of cameras may be envisioned without deviating from the scope of the present invention.

In another preferred embodiment of the present invention, the helmet system 108 further includes a memory unit (not shown in FIG. 3A) for storing the digital content for a pre-defined duration before the sudden change in the speed of the vehicle detected by the accelerometer (124, shown in FIG. 1). The accelerometer (124, shown in FIG. 1) sends notifications over the communication network through the second communication unit (116, shown in FIG. 1) on detecting sudden change in the speed of the vehicle.

For exemplary purposes, the pre-defined duration is 30 seconds. In case of accident, reduced heart beats, low blood pressure or a crash, the vehicle stops immediately and thus the accelerometer detects the change in the speed and communicates the digital recording of last 30 seconds from the crash/accident over the communication network through the second communication unit.

In another preferred embodiment of the present invention, the accelerometer 124 is a 3-axis accelerometer. The accelerometer 124 identifies the movement of the head of the rider. The memory unit stores instructions related to movement of head of the rider. The microprocessor processes the movements of the head received from the accelerometer and illuminates the LED lights 120 accordingly.

For exemplary purposes, the rider moves the head to right, the accelerometer then detects the head movement and the microprocessor then illuminates the right LED light 120a. Thus, the directional signal from the accelerometer is processed by the microprocessor to operate the LED light 120.

FIG. 3B is a rear view of the helmet 104 showing position of LED lights 120 in accordance with a preferred embodiment of the present invention. In addition to the LED lights 120 on the front of the helmet 104, additional LED lights 120 are configured on the rear of the helmet 104.

The LED lights 120 on the rear of the helmet 104 helps the rider and person approaching the vehicle from behind to identify the location, position and turning of the vehicle. Further, the LED lights 120 include a second left LED light 120e, a second right LED light 120f and a brake light 120g.

The second left LED light 120e illuminates when the rider moves the joystick in left direction. The illumination of the second left LED light 120e indicates that the vehicle is about to turn in left direction. The second right LED light 120f illuminates when the rider moves the joystick in the right direction. The illumination of the second right LED light 120f indicates that the vehicle is about to turn in right direction.

The brake light 120g illuminates when the rider moves the joystick in rear direction. The illumination of the brake light 120g indicates that the vehicle is about to stop as the rider has applied brakes. It would be readily apparent to those skilled in the art that various number, color and shapes of LED lights 120 may be envisioned without deviating from the scope of the present invention.

In another preferred embodiment of the present invention, the helmet system 108 includes a USB port 304 to receive a power cable to charge the second battery. Further, the helmet system 108 includes a smart microphone (not shown in FIG. 3B) for wirelessly operating a smartphone on filtering noise from voice commands of the rider.

In another preferred embodiment of the present invention, the smart microphone provides direct voice command to the microprocessor to operate the plurality of LED lights via the second communication unit. It would be obvious to those skilled in the art that various types of smart microphone may be envisioned without deviating from the scope of the present invention. The smart microphone provides hands-free environment to the rider to control the smartphone and the plurality of LED lights 120.

In another preferred embodiment of the present invention, the helmet system 108 further includes a wireless charging unit (not shown in FIG. 3B) to wirelessly charge the first battery and the second battery. Examples of the wireless charging unit includes but not limited to any device working on the principle of radio, inductive, and resonance charging.

In another preferred embodiment of the present invention, the helmet system 108 further includes a proximity sensor 306 to detect approaching vehicles. The proximity sensor 306 sends signal to the microprocessor to illuminate the position light 120d as a warning signal for approaching vehicles.

The proximity sensor 306 detects approaching of vehicles from all possible angles. The proximity sensor 306 may further send the notification of detection of vehicles to the smartphone via the second communication unit. Examples of the proximity sensor include but not limited to IR, camera, depth sensors, ultrasonic sensors, combination of at least two proximity sensors etc.

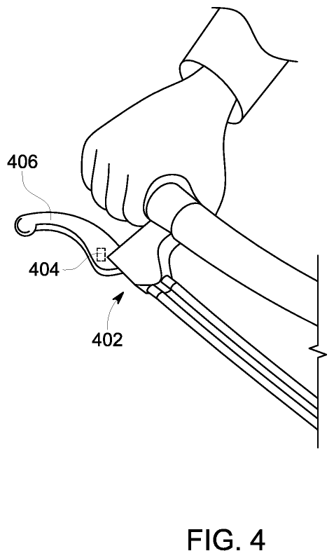

FIG. 4 illustrates a perspective view of a vehicle braking unit 402 in accordance with another preferred embodiment of the present invention. The vehicle system (106, shown in FIG. 1) includes a brake sensor 404 configured in the vehicle braking unit 402 to sense braking of the vehicle.

The brake sensor 404 further communicates the braking of the vehicle to the microprocessor through the first communication unit. The microprocessor operates the brake light (120g, shown in FIG. 3) to indicate application of brakes by the rider.

In an exemplary embodiment of the present invention, the brake sensor 404 is configured in the bicycle/tricycle. The braking sensor 404 detects the squeezing of the braking handle 406. The braking sensor 404 senses the separation of the metal braking handle 406 from the resting spot.

Further in another preferred embodiment of the present invention, the braking sensor 404 includes a camera to visually detect the squeezing of the braking handle 406 and the sending the detection to the microprocessor to process the signal via the first communication unit.

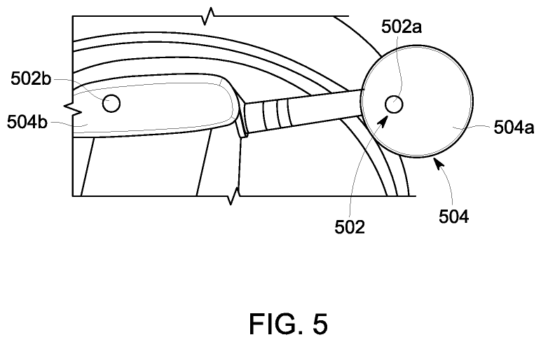

FIG. 5 illustrates a rear view of the vehicle 500 illustrating attachment of light sensors 502 to light sources 504 in accordance with another preferred embodiment of the present invention. The vehicle system further includes plurality of light sensors 502 such as 502a, 502b.

The light sources 504 illuminates using the vehicle electronic circuitry and on action caused by the rider. In a preferred embodiment of the present invention, the vehicle 500 is a motorcycle, motorbike and any similar two or three wheeler motorbikes.

For exemplary purposes, the light sensor 502a sticks to the right indicator light source 504a. When the rider moves the indicator of the vehicle to the right, the right indicator light source 504a is illuminated. The light sensor 502a detects the illumination of the right indicator light source 504a. The light sensor 502a then sends the signal to the microprocessor via the first communication unit. The microprocessor then operates the right LED light.

Similarly, the light sensor 502b sticks to the brake light source 504b. The light sensor 502b detects the illumination of the brake light source 504b when the rider applies brake. The light sensor 502b then sends the signal to the microprocessor via the first communication unit. The microprocessor then operates the brake light.

Similarly, the light sensor 502 is attached to the left indicator light source to detect illumination. The light sensor 502 then sends the signal to the microprocessor via the first communication unit. The microprocessor then operates the left LED light.

In another preferred embodiment of the present invention, at least one first communication is attached to each light source 504 of the vehicle 500. The first communication unit communicates the illumination of the light source to the microprocessor via the second communication unit. The microprocessor controls the operation of the LED lights.

For exemplary purposes, the first communication unit is connected to the right source 504a directly sends the right turning signal to the second communication unit when the rider moves indicator button on right. The microprocessor processes the right turning signals received by the second communication unit. Further, the microprocessor commands the right LED light to illuminate to send signals to the nearby person.

The present invention offers various advantages such as allowing approaching people and animals to identify position and movements of the vehicle. Further, the present invention is a wireless system which is able to be configured with existing vehicle systems. Furthermore, the system provides no internal wiring in the vehicle to communicate with other elements of the vehicle in order to send illumination signals to the helmet.

The invention may be susceptible to various modifications and alternative forms, and specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A lighting and communication system for providing communication between a vehicle and a helmet worn by a rider over a communication network, the lighting and communication system comprising:
a vehicle system attached to a handle of the vehicle, the vehicle system comprising:
a joystick attached to the frame of the vehicle for allowing the rider to provide directional signals;
a first communication unit configured in the joystick for communicating directional signals with the helmet over the communication network; and
a first battery configured to power the joystick and the first communication unit;
a helmet system attached to the helmet for communicating with the vehicle system, the helmet system comprising:
a second communication unit attached to the helmet to receive the directional commands from the joystick via the first communication unit;
a microprocessor attached to the helmet to process the directional commands received by the second communication unit from the first communication unit, wherein the second communication unit communicates the processed signals over the communication network;
plurality of LED lights configured on the helmet to indicate movement of the vehicle based upon the movement of the joystick initiated by the rider; and
a second battery configured in the helmet to power the plurality of LED lights, the second communication unit and the microprocessor;
wherein the microprocessor controls the operation of the LED lights, wherein the LED lights illuminate based on the directional signals from the joystick to reflect movement of the vehicle.

2. The lighting and communication system according to claim 1, wherein the vehicle system further comprising a brake sensor configured in a vehicle braking unit to sense braking of the vehicle, further the brake sensor communicates the braking of the vehicle to the microprocessor through the first communication unit; wherein the microprocessor operates at least one of the LED lights to indicate application of brakes by the rider.

3. The lighting and communication system according to claim 1 wherein the helmet system further comprising a speed unit for communicating speed and sudden change in speed of the vehicle over the communication network via the second communication unit.

4. The lighting and communication system according to claim 1 wherein the helmet system further comprising a proximity sensor to detect approaching vehicles and further illuminates at least one of the plurality of LED lights as warning signal for approaching vehicles.

5. The lighting and communication system according to claim 1 wherein the vehicle system further comprising a health sensor configured on the frame zo of the vehicle to detect various health parameters of the rider, further the health sensor communicates the health parameters through the communication network via the second communication unit.

6. The lighting and communication system according to claim 3 wherein the helmet system further comprising at least one camera to record digital content around the vehicle, further the camera communicates the recorded digital content over the communication network via the second communication unit.

7. The lighting and communication system according to claim 6 wherein the helmet system further comprising a memory unit to store the digital content for a pre-defined duration before the sudden change in the speed of the vehicle detected by the accelerometer, further wherein the accelerometer sends notifications over the communication network through the second communication unit on detecting sudden change in the speed of the vehicle.

8. The lighting and communication system according to claim 1 wherein the helmet system further comprising a USB port to receive a power cable to charge the second battery.

9. The lighting and a communication system according to claim 1 wherein the helmet system further comprising a smart microphone for wirelessly operating a smartphone on filtering noise from voice commands of the rider.

10. The lighting and a communication system according to claim 1 further comprising wireless charging unit to wirelessly charge the first battery and the second battery.

11. A lighting and communication system for providing communication between a vehicle and a helmet worn by a rider over a communication network, the lighting and the communication system comprising:
a vehicle system attached to a handle of the vehicle, the vehicle system comprising:
plurality of light sensors, wherein at least one light sensor attached to at least one light source of the vehicle, wherein the light sensor detects illumination of the light source, further the light sensor generates directional and light signal corresponding to the movement of the vehicle; and
a first battery configured to power the light sensors;
a helmet system attached to the helmet for communicating with the vehicle system, the helmet system comprising:
a second communication unit attached to the helmet to receive the light signal from the light sensor;
a microprocessor attached to the helmet to process the light signals and the directional signals received by the second communication unit from the light sensors, wherein the light signals and directional signals determines the movement of the vehicle;
plurality of LED lights, wherein at least one of the LED lights illuminate to show movement of the vehicle corresponding to the light signals received from the light sensors; and
a second battery attached to the helmet to power the plurality of LED lights, the second communication unit and the microprocessor;
wherein the microprocessor controls the operation of the LED lights, wherein the LED lights illuminate based on the light signals and the directional signals from the light sensors to reflect movement of the vehicle.

12. The lighting and a communication system according to claim 11 wherein the vehicle system further comprising plurality of first communication units, wherein each first communication unit is attached to each light source of the vehicle, wherein the first communication unit communicates the light signals and the directional signals of the light source to the microprocessor via the second communication unit, wherein the microprocessor controls the operation of the LED lights.

13. The lighting and a communication system according to claim 11 wherein the helmet system further comprising a proximity sensor to detect approaching vehicles and further illuminates at least one of the plurality of LED lights as a warning signal for approaching vehicles.

14. The lighting and a communication system according to claim 11 wherein the vehicle system further comprising a health sensor configured on the frame of the vehicle detects various health parameters of the rider, further the health sensor communicates the health parameters to the communication network through the second communication unit via the first communication unit.

15. The lighting and a communication system according to claim 11 further comprising solar cells to power the first battery and the second battery.

16. The lighting and a communication system according to claim 11 further comprising wireless charging station to wirelessly charge the first battery and the second battery.

17. The lighting and a communication system according to claim 11 wherein the helmet system further comprising a USB port to receive a power cable to charge the second battery.

18. The lighting and a communication system according to claim 11 wherein the helmet system further comprising a smart microphone for wirelessly operating a smartphone on filtering noise from voice commands of the rider.
